(19) United States
(12) Patent Application Publication
(10) Pub. No.: US 2008/0250320 A1
(43) Pub. Date: Oct. 9, 2008

(54) User-defined media annotations on dynamic charts

(75) Inventors: Brian Paul Channell, Redondo Beach, CA (US); Thanhy Mather, Saratoga, CA (US)

Correspondence Address: MORRISON & FOERSTER LLP, 425 MARKET STREET, SAN FRANCISCO, CA, 94105-2482, US

(73) Assignee: YAHOO! INC., Sunnyvale, CA (US)

(21) Appl. No.: 11/903,773

(22) Filed: Sep. 24, 2007

Related U.S. Application Data
(63) Continuation-in-part of application No. 11/732,863, filed on Apr. 4, 2007.

(51) Int. Cl. G06F 3/00

(52) U.S. Cl. 715/716

(57) ABSTRACT

In accordance with embodiments of the invention, a method for providing a customizable media indicator on a dynamically generated graphical representation of real-time data is provided. The method includes receiving a user-defined request from a user to annotate the real-time data with at least one media indicator. Together with the dynamically generated graphical representation of the real-time data, the at least one media indicator is provided for display at a client. The method further includes receiving a first external media data defined by the user for association with the media indicator. The first media data is provided in response to a user action associated with the at least one media indicator. The at least one media indicator is sharable with a plurality of users.

### CROSS-REFERENCE TO RELATED APPLICATIONS

This application is a continuation-in-part application of application Ser. No. 11/732,863 filed Apr. 4, 2007, entitled “USER-DEFINED VISUAL INDICATORS ON DYNAMIC CHARTS”, the content of which is incorporated herein in its entirety.

### BACKGROUND OF THE INVENTION

Dynamically generated charts provide a visual representation of real-time data quickly to a client in a client/server architecture. Utilizing dynamically generated charts for displaying financial data, such as data related to stocks, allows for an accurate visualization of data that is constantly changing. Providing symbols, or indicators, indicating potentially relevant information related to the data series displayed on a dynamic chart may be useful in analyzing trends and explaining data fluctuations.

Previously, finance-related dynamic charts would provide indicators to signal splits, dividends, or news stories associated with a particular data series displayed in a dynamic chart. An example of a finance dynamically generated chart is a chart displaying the stock price plot from a past time to the current time the chart is generated. Symbols can also be displayed on the dynamic chart, such as statistical, or technical, indicators, indicating splits and dividends displayed along the corresponding price and time of the stock price plot.

In other finance-related dynamic charts, the chart displays a stock price plot along with relevant news article indicators, which indicate the time the news article was released. The news indicator indicates to a user that the news article may have had some impact on the stock price. However, a news article irrelevant to a stock trader or buyer may falsely indicate a possible source for a stock price fluctuation.

In other cases, technical analysis indicators provide useful information to a user. However, the technical indicators provide only limited insight into the data series displayed on the dynamic chart. These types of predefined technical indicators are options provided to a user. The user may then choose which indicators they would like to be displayed on the chart. However, the indicators are not defined by the user, and the user may not customize the indicator according to specific conditions the user may be interested in. Moreover, purely technical indicators do not show the impact of the indicated event on a group of people or an individual, or the social sentiment at the time that may affect the real-time data series on a dynamic chart.

Therefore, the ability for a user to define visual indicators with media content from more than one source on a dynamically generated chart is desired.

### BRIEF SUMMARY OF THE INVENTION

In accordance with embodiments of the invention, a method for providing a customizable media indicator on a dynamically generated graphical representation of real-time data is provided. The method includes receiving a user-defined request from a user to annotate the real-time data with at least one media indicator. Together with the dynamically generated graphical representation of the real-time data, the at least one media indicator is provided for display at a client. The method further includes receiving a first external media data defined by the user for association with the media indicator. The first media data is provided in response to a user action associated with the at least one media indicator. The at least one media indicator is sharable with a plurality of users.

In accordance with some embodiments of the present invention, a method for providing a customizable media indicator on a dynamically generated graphical representation of real-time data is provided. The method includes receiving the real-time data and a user-defined condition from a user to annotate the real-time data with at least one media indicator. The at least one media indicator provides media data to the user in response to a user action associated with the at least one media indicator. The method further includes determining the media indicator data related to the real-time data. Displaying a graphical representation of the real-time data and the at least one media indicator is accomplished using the media indicator data.

Other features and aspects of the invention will become apparent from the following detailed description, taken in conjunction with the accompanying drawings which illustrate, by way of example, the features in accordance with embodiments of the invention. The summary is not intended to limit the scope of the invention.

### BRIEF DESCRIPTION OF THE DRAWINGS

FIG. 1 illustrates a dynamic flash-based stock price versus time chart including technical indicators;

FIG. 2 illustrates a user interface in a window for defining a media indicator according to embodiments of the invention;

FIG. 3 illustrates a dynamic chart displaying the media annotation according to embodiments of the invention;

FIG. 4 illustrates a media annotation that has been modified by other users to add additional annotations according to embodiments of the invention;

FIG. 5 is a flowchart illustrating a method of generating a user-defined media indicator on a dynamic chart according to embodiments of the invention;

FIG. 6 is a block diagram illustrating a system for providing the media indicator on a dynamic chart for displaying the media annotation according to embodiments of the invention;

FIG. 7 illustrates displaying user-defined media annotations to a community of users; and

FIG. 8 is a block diagram of an embodiment of a computer system.

The present invention and its various embodiments are better understood upon consideration of the detailed description below in conjunction with the accompanying drawings and claims.

In the following description, reference is made to the accompanying drawings which form a part thereof, and which illustrate several embodiments of the present invention. It is understood that other embodiments may be utilized and structural and operational changes may be made without departing from the scope of the present invention. The use of the same reference symbols in different drawings indicates similar or identical items.

### DETAILED DESCRIPTION OF THE INVENTION

The following description is presented to enable any person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

By enriching dynamic charts with user comments and opinions through media-type files, additional insight is gained for a particular stock trends and anomalies that may not be otherwise be captured by pure technical analysis. This may more accurately detect trade opportunities or limit risks for an existing trade position.

Media annotations may have many uses. For example, high frequency of media annotations may mean that the news event has a significant impact on the stock market, while a low frequency may mean that this news event may have an insignificant impact on the stock market. Alternatively, the media annotations allow users to express positive or negative opinions to a community of users. In general, media annotations may be a quantitative representation of opinions, attitude, or bias for any topic such as an instrument, asset, product, or company.

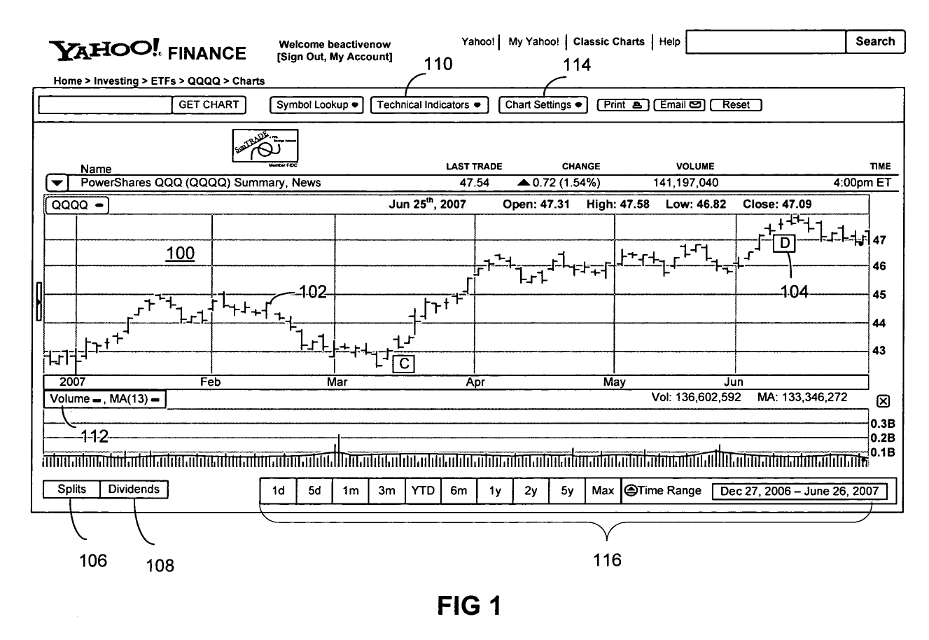

FIG. 1 illustrates a dynamically generated chart with finance-related data. In this embodiment of a dynamic chart 100, the finance-related data is a stock price plot 102 over a 6-month time period. A statistical, or technical, indicator may be displayed along with the stock price plot 102 indicating the point in time an event or statistical condition was met. A dividend indicator 104 is displayed along plot 102 in mid-June. These types of indicators may be toggled on or off by the user using the user-interface buttons 106 and 108, for example. Other technical indicators may be displayed along the plot 102 by choosing the indicator from the menu 110. These technical indicators may include, for example, statistical data, such as moving average and standard deviations. Moreover, the volume 112 may also be displayed on the same dynamic chart 100. The time range displayed can be dynamically adjusted with the time range buttons 116 provided in the user interface. Along the plot 102 on the dynamic chart 100, a user may want to annotate the plot at a specific point, including reasons or comments, for example, related to that specific point. The user may click on the point along the plot to indicate the associated real-time data for generating the media indicator.

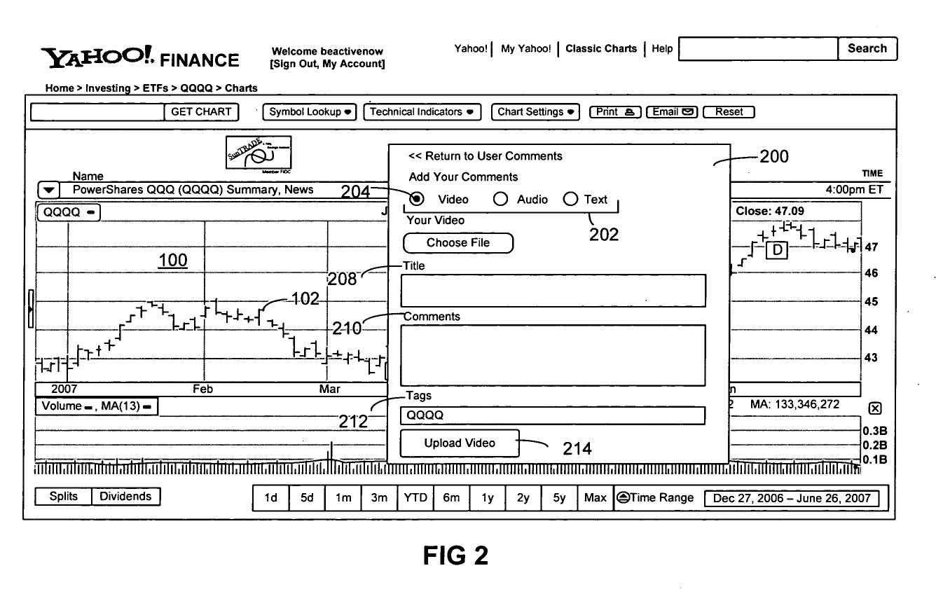

According to some embodiments of the invention, after selecting the point as the user condition for generating the media indicator, the user may be presented an interface in order to define the indicator and its associated media data. FIG. 2 illustrates a user interface in a window for defining a media indicator. A separate window 200 may be provided to the user defining the media indicator and annotation. The window 200 provides options for media types 202 for the annotation. In this exemplary embodiment, the video media type option 204 is selected. The user is provided a functional button 206 within the window 200 to choose the media file desired for the annotation by browsing the client system. The user is able to define a title 208, include comments related to their annotation 210, and include tags 212. Additionally, an upload video functional button 214 is provided that activated when the user would like to upload their video to the server storage to complete defining the media indicator on the dynamic chart and the annotation provided when the media indicator is activated. Furthermore, a user may be able to display a time series display of annotations defined by himself, or the time series display of annotations, defined by any user, related to a dynamic chart. In this way, the user may visually see the chronological order of media annotations.

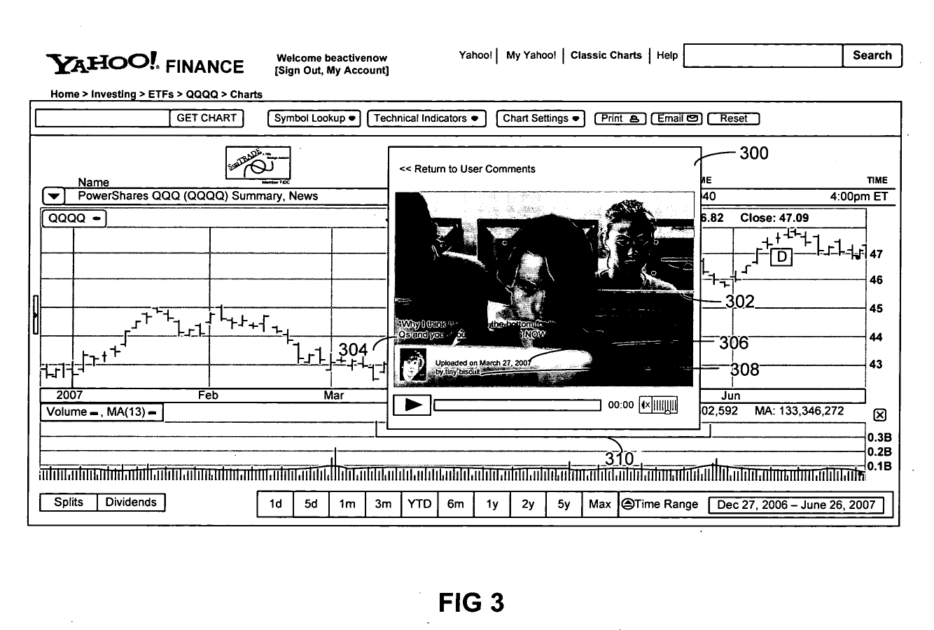

FIG. 3 illustrates a dynamic chart displaying the media annotation according to embodiments of the invention. In response to a mouseover event, or a click event, the media indicator on the dynamic chart is activated and the media annotation 300 is provided. The media annotation provides the external media data uploaded by the user. In this embodiment, the external media data includes the video 302 defined by the user who defined this annotation. The ID 308 of the user who defined the media annotation 300 is indicated on the annotation along with the comments 304 the user provided along with the media file for the annotation. Moreover, the date 306 the user defined the indicator and annotation is provided. Controls 310, including a play button, volume control, and time indicator, to activate the video file are provided on the media annotation 300.

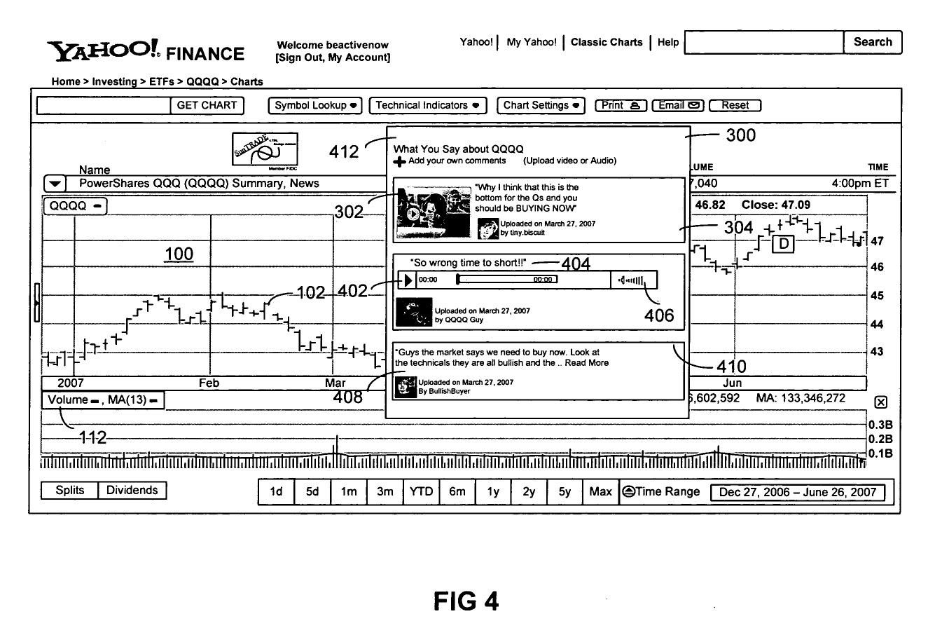

FIG. 4 illustrates a media annotation that has been modified by other users to add additional annotations according to embodiments of the invention. A media indicator and its associated media annotation is sharable with a community of users. Another user in the community of users, who did not originally define the media indicator, may be provided the media indicator. The user may then choose to add his own annotation to the original media annotation. The user may activate the media indicator and be provided the media annotation 300. To add to the media annotation, the user activates the function labeled “Add your own comments” 412. This function 412 allows a user to add additional external media data. A second media external data provided by another user may be an audio file. The audio file is included in a second portion 402 of the media annotation 300. Since the second media external data is an audio file, audio controls 406 are provided in the media annotation 300. Additionally, a comment 404 related to the audio file 402 may be provided. A third user may also add to the media annotation 300. This is displayed in a third portion 408 of the media annotation 300. The comment 410 is provided to any one of a plurality of users that may access the media indicator.

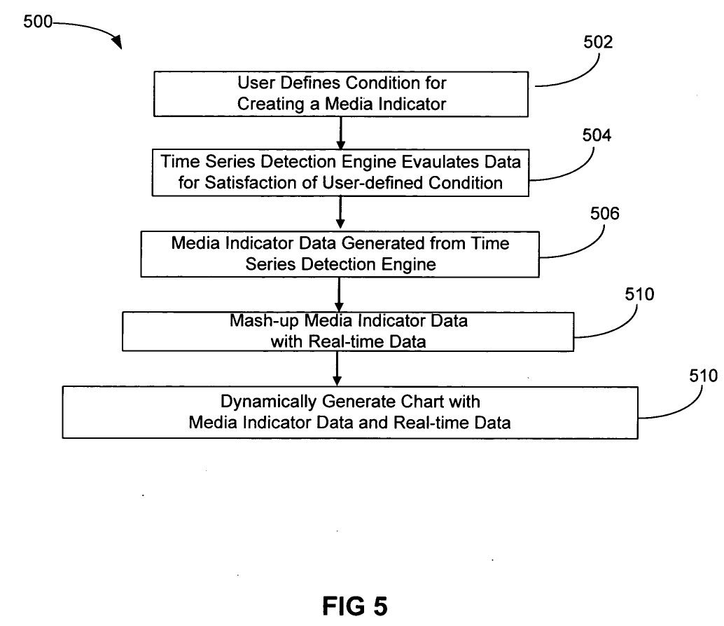

FIG. 5 is a block diagram illustrating a method for providing the media indicator on a dynamic chart for displaying the media annotation for a user of a plurality of users, at a client, according to embodiments of the invention. The user who authored the media indicator defines a condition for generating the media indicator 502. A user-defined condition for generating a media indicator may be a data point of the real-time data. The user-defined condition is evaluated in, for example, a time series detection engine in 504. A database may also be used to evaluate the user-defined condition. The time series detection engine determines a media indicator data series, which comprises the decisions at 506 by the time series detection engine concerning the satisfaction of the user-defined condition. If the user-defined condition is satisfied, the media indicator data will be combined with the real-time data series in 508 (“mash-up data”), and a media indicator will be provided on the dynamic chart. A mash-up is known in the art as a combination of content from more than one source to provide an integrated application. The mash-up data is used to dynamically generate a dynamic chart in 510 to display the real-time data series and the media indicators, which indicate the satisfaction of the user-defined condition related to the real-time data.

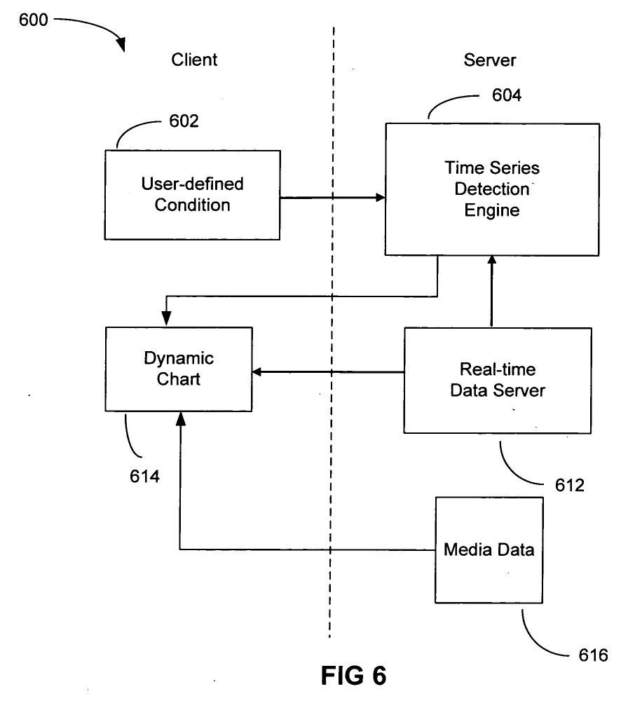

FIG. 6 illustrates a block diagram of the system 600 according to embodiments of the present invention. A user-defined condition 602 for a visual indicator originates from a client-side user. A time series detection engine 604 receives the user-defined condition 602, and any external data needed for the user-defined condition. The external data may include news 606, financial analyst data 608, and web log (blog) data 610, for example. The time series detection engine 604 also receives the real-time data for evaluation of the user-defined condition 602. The time series detection engine 604 evaluates the user-defined condition and determines whether the user-defined condition is satisfied in media indicator data. A database may be used to evaluate the user-defined condition 602. The client-side display 614 receives the media indicator data and associated real-time data from the real-time data server 612 and dynamically generates a graphical representation of the real-time data and user-defined media indicators. As the media indicators are activated, such as by a mouseover event, the external media data associated with the activated media indicator stored in a memory 616, is provided to the client-side display 614.

In some embodiments, the user-defined media indicators may also be publicly shared with a chosen user or community of users and stored. Users with proper permissions granted by the user who originally defined the conditions may also add annotations to the media indicators. All user-defined conditions may be stored in persistent storage on the client-side or server-side.

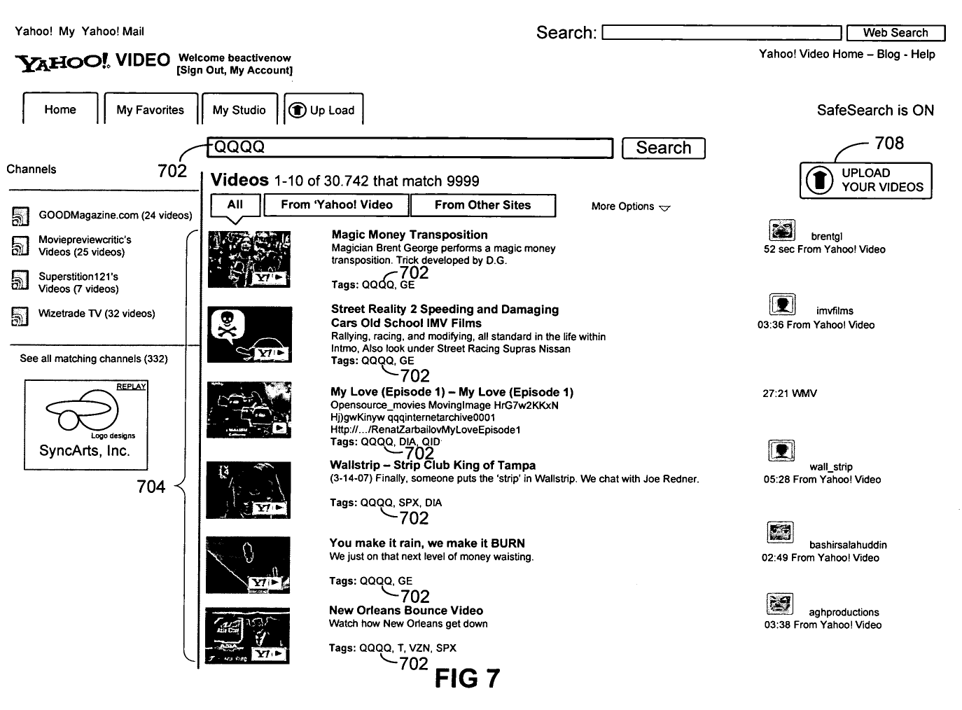

Furthermore, external media data may be uploaded from a user's client side computer to the shared memory 616. The user may upload video, audio, text, and images, for example, but is not limited to, as external media data. Documents may also be uploaded for the annotation, such as PDF files or Excel spreadsheets. As the external media data, such as videos, is uploaded, the user may also define at least one tag to characterize, or label, the media data that is being uploaded. In this way, a user may also search for media annotations users have defined related to a tag. FIG. 7 illustrates displaying user-defined media annotations to a community of users. A user may search for a tag “QQQQ” 702 and be provided media annotations as search results that match the tag 704.

While aspects of the invention, including the above described systems and methods, are described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic, and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

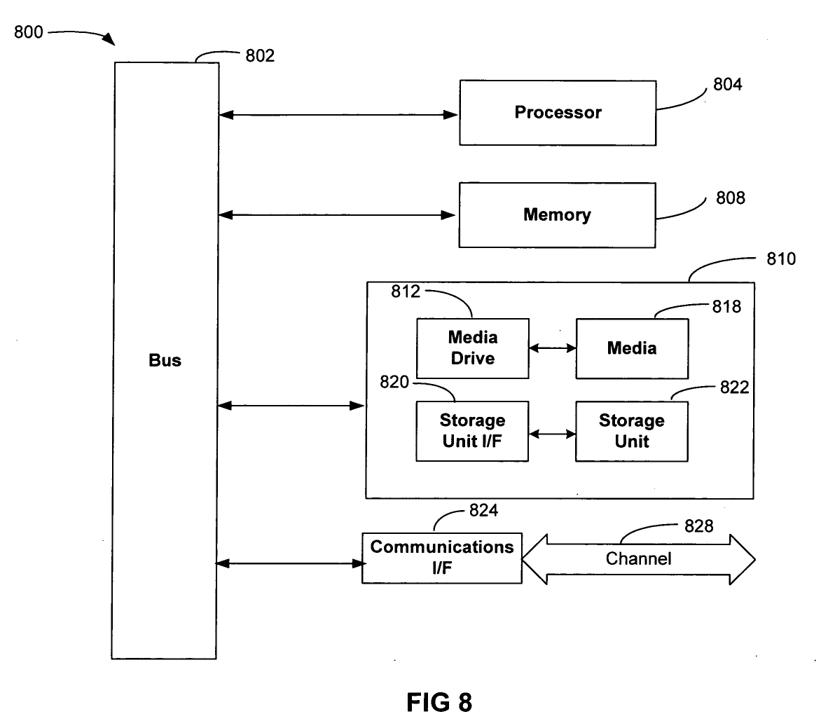

FIG. 8 illustrates an exemplary computing system 800 that may be employed to implement processing functionality for various aspects of the invention (e.g., as a time series detection engine, client device, database, server device, combinations thereof, and so on). Those skilled in the relevant art will also recognize how to implement the invention using other computer systems or architectures. Computing system 800 may represent, for example, a desktop, mainframe, server, client, or any other type of special or general purpose computing device as may be desirable or appropriate for a given application or environment. Computing system 800 can include one or more processors, such as a processor 804. Processor 804 can be implemented using a general or special purpose processing engine such as, for example, a microprocessor, microcontroller or other control logic. In this example, processor 804 is connected to a bus 802 or other communication medium.

Computing system 800 can also include a main memory 808, for example random access memory (RAM) or other dynamic memory, for storing information and instructions to be executed by processor 804. Main memory 808 also may be used for storing temporary variables or other intermediate information during execution of instructions to be executed by processor 804. Computing system 800 may likewise include a read only memory (“ROM”) or other static storage device coupled to bus 802 for storing static information and instructions for processor 804.

The computing system 800 may also include information storage mechanism 810, which may include, for example, a media drive 812 and a removable storage interface 820. The media drive 812 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 818 may include, for example, a hard disk, floppy disk, magnetic tape, optical disk, CD or DVD, or other fixed or removable medium that is read by and written to by media drive 814. As these examples illustrate, the storage media 818 may include a computer-readable storage medium having stored therein particular computer software or data.

In alternative embodiments, information storage mechanism 810 may include other similar instrumentalities for allowing computer programs or other instructions or data to be loaded into computing system 800. Such instrumentalities may include, for example, a removable storage unit 822 and an interface 820, such as a program cartridge and cartridge interface, a removable memory (for example, a flash memory or other removable memory module) and memory slot, and other removable storage units 822 and interfaces 820 that allow software and data to be transferred from the removable storage unit 818 to computing system 800.

Computing system 800 can also include a communications interface 824. Communications interface 824 can be used to allow software and data to be transferred between computing system 800 and external devices. Examples of communications interface 824 can include a modem, a network interface (such as an Ethernet or other NIC card), a communications port (such as for example, a USB port), a PCMCIA slot and card, etc. Software and data transferred via communications interface 824 are in the form of signals which can be electronic, electromagnetic, optical, or other signals capable of being received by communications interface 824. These signals are provided to communications interface 824 via a channel 828. This channel 828 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 808, storage device 818, storage unit 822, or signal(s) on channel 828. These and other forms of computer-readable media may be involved in providing one or more sequences of one or more instructions to processor 804 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into computing system 800 using, for example, removable storage drive 814, drive 812 or communications interface 824. The control logic (in this example, software instructions or computer program code), when executed by the processor 804, causes the processor 804 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention. Moreover, aspects of the invention describe in connection with an embodiment may stand alone as an invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A method for providing a customizable media indicator on a dynamically generated graphical representation of real-time data, the method comprising:
receiving a user-defined request from a first user to annotate the real-time data with at least one media indicator;
providing, for display at a client, the at least one media indicator together with the dynamically generated graphical representation;
receiving first external media data defined by the first user for association with the media indicator; and
providing the first external media data in response to a user action associated with the at least one media indicator, wherein the at least one media indicator is sharable with a plurality of users.

2. The method of claim 1, wherein the at least one media indicator references at least one other previously defined media indicator.

3. The method of claim 1, wherein the at least one media indicator is modified by another user.

4. The method of claim 1 further comprising receiving a second external media data from a second user, wherein, in response to a user action associated with the at least one media indicator, providing the first external media data and the second external media data.

5. The method of claim 1, wherein the first external media data includes video data.

6. The method of claim 1, wherein the first external media data includes audio data.

7. The method of claim 1, wherein the first external media data includes image data.

8. The method of claim 1, wherein the first external media data includes a URL link.

9. The method of claim 1, wherein the first external media data includes a document file.

10. The method of claim 1, wherein providing the first external media data further comprises providing a separate area than an area for displaying the graphical representation of real-time data, for displaying the external media data.

11. The method of claim 10, further comprising providing at least one advertisement along with the first external media data in the separate area.

12. The method of claim 1, further comprising storing tags associated with the first external media data.

13. A method for providing a customizable media indicator on a dynamically generated graphical representation of real-time data, the method comprising:
receiving the real-time data;
receiving a user-defined condition from a first user to annotate the real-time data with at least one media indicator, wherein, in response to a user action associated with the at least one media indicator, providing to the user media data;
determining media indicator data related to the real-time data;
using the media indicator data for displaying a graphical representation of the real-time data and the at least one media indicator.

14. An apparatus for annotating a visual indicator for providing a customizable media indicator on a dynamically generated graphical representation of real-time data, the apparatus comprising:
logic for receiving a user-defined request from a first user to annotate the real-time data with at least one media indicator,
logic for receiving a first external media data associated with the media indicator defined by the first user;
a memory for storing the at least one media indicator and the external media data;
display means for providing the at least one media indicator along with the dynamically generated graphical representation; and
logic for providing the first external media data along with the at least one media indicator in response to a user action associated with the at least one media indicator, wherein the at least one media indicator is sharable with a plurality of users.

15. The apparatus of claim 14, wherein the memory for storing the at least one media indicator and the first external media data is a database.

16. The apparatus of claim 14, wherein the logic for receiving a user-defined request is a processor.

17. The apparatus of claim 14, wherein the logic for receiving a user-defined request is a time series detection engine.

18. The apparatus of claim 14, wherein the memory is a sharable memory for sharing with a plurality of users.

19. The apparatus of claim 14, wherein the logic for providing the external media data is a separate display area than a display area for displaying the graphical representation of real-time data.

20. The apparatus of claim 19, wherein the display means is further for providing at least one advertisement along with the external media data in the separate area.

21. A computer-readable medium comprising program code for annotating a visual indicator on a dynamically generated graphical representation of real-time data with a customizable media indicator, the program code for:
receiving a user-defined request from a first user to annotate the real-time data with at least one media indicator;
providing, for display at a client, the at least one media indicator together with the dynamically generated graphical representation;
receiving first external media data defined by the first user for association with the media indicator; and
providing the first external media data in response to a user action associated with the at least one media indicator, wherein the at least one media indicator is sharable with a plurality of users.

22. The computer-readable medium of claim 21, wherein the program code for providing the first external media data further comprises program code for providing a separate area for displaying the first external media data.

23. The computer-readable medium of claim 22, further comprising program code for providing at least one advertisement along with the external media data in the separate area.

24. The computer-readable medium of claim 21, wherein the at least one media indicator is modified by another user.
